(19) United States
(12) Patent Application Publication
(10) Pub. No.: US 2026/0350415 A1
(43) Pub. Date: Nov. 5, 2026

(54) COMPUTER SYSTEM AND METHOD FOR TRAINING AND UTILIZING A MACHINE LEARNING MODEL FOR DETERMINING PERSONALIZED COSTS ASSOCIATED WITH HEALTHCARE AND LONG-TERM CARE

(71) Applicant: The Prudential Insurance Company of America, Newark, NJ (US)

(72) Inventors: Wei Zhao, Jersey City, NJ (US); Yamei Tu, Newark, NJ (US)

(73) Assignee: The Prudential Insurance Company of America, Newark, NJ (US)

(21) Appl. No.: 19/196,217

(22) Filed: May 1, 2025

(51) Int. Cl. G06N 3/0985; G06N 3/04

(52) U.S. Cl. CPC G06N 3/0985; G06N 3/04

(57) ABSTRACT

A computer system and method/process for training a machine learning (ML) model for determining personalized costs associated with both long-term care (LTC) and healthcare, expressed as predictive distribution. One or more external and internal datasets are accessed having data related to LTC and healthcare, which are then subject to cleansing such that each accessed dataset is suitable for being aggregated in a training dataset for training one or more ML models relating to LTC and healthcare predictions. A training dataset is then complied by aggregating each of the accessed datasets, wherein the training dataset is operative to train one or more ML models associated with predicting costs relating to LTC and healthcare. LTC and healthcare cost ML models are trained using the training dataset. Each of the LTC and healthcare cost ML models includes one or more ML model modules, each configured and operative to employ one or more artificial intelligence (AI) techniques for generating cost predictions based on input data associated with a prediction request.

### BACKGROUND

### 1. Field

Artificial Intelligence (AI) based system, apparatus and processes for performing predictive analytics and machine learning-based systems for generating personalized long-term care, and/or healthcare expense projections, and more particularly to computational methodologies for processing and harmonizing multiple healthcare, and health-related, data sources and training machine learning (ML) models to generate actionable data suitable for use in financial planning.

### 2. Description of Related Art

Long-term care (LTC) and healthcare expenses represent increasingly significant financial challenges for individuals, families, and financial institutions in contemporary society. The complexity and magnitude of such expenses create substantial difficulties in financial planning and risk management processes. Existing methodologies for expense prediction and financial planning often fail to provide accurate, actionable insights due to various technological limitations described herein. The absence of reliable predictive tools has resulted in widespread financial planning inefficiencies, whereby individuals and institutions frequently underestimate, or overestimate required LTC financial and/or healthcare reserves. Such miscalculations can result in substantial adverse financial consequences for stakeholders across the LTC and healthcare ecosystems.

Traditional approaches to personal healthcare and LTC cost estimation have primarily relied upon actuarial models and rule-based systems. While actuarial models provide robust analytical capabilities, such models are inherently limited by their reliance on historical data and inability to integrate dynamic factors including, but not limited to, emerging health trends, personalized patient data, evolving healthcare and LTC costs, and regional economic variations. Similarly, rule-based systems exhibit limited adaptability to new data and often produce oversimplified predictions that fail to account for the complex interplay of individual health trajectories and demographic factors.

Recent implementations of machine learning technologies in the healthcare and LTC technology fields have introduced new predictive capabilities. However, such implementations are characterized by significant limitations, including: (a) insufficient data depth due to reliance on single data sources, whereby the resultant predictions fail to capture the full complexity of healthcare and LTC cost trajectories; (b) lack of interpretability of predictive outputs, whereby the “black box” nature of such systems causes limited trust and adoption among stakeholders; and (c) fragmented analytical approaches that fail to provide integrated cost projections, resulting in isolated insights that do not adequately address the interconnected nature of healthcare and LTC expenses.

Insurance providers face particular challenges in implementing existing solutions, whereby the absence of granular predictive capabilities impedes accurate premium calculations and risk assessment processes. Traditional methodologies fail to adequately account for individual variation in health status, lifestyle factors, and regional cost differences, resulting in suboptimal pricing strategies and potential risk exposure.

Furthermore, current systems exhibit significant limitations in their ability to adapt to evolving health landscapes, whereby rapid changes in medical technology, treatment protocols, and care delivery models necessitate increased sophisticated predictive capabilities than those provided by existing solutions. The limitations of current technologies create a significant need for more advanced, integrated approaches to healthcare and LTC cost prediction and financial planning.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

It is to be understood and appreciated the illustrated embodiments described herein provide a solution to the long-standing problem of healthcare and LTC cost computer prediction by implementing advanced computational methodologies in conjunction with comprehensive data integration. In one illustrated embodiment, the described system and process is implemented through a web-based application interface, enabling partner access while maintaining capability for application programming interface (API) integration.

It is to be further understood and appreciated the illustrated embodiments described herein relate to predictive analytic computer systems in personalized healthcare and LTC cost estimation, and more particularly to machine learning-based computer systems for generating personalized healthcare and LTC expense projections. Specifically, the illustrated embodiments include computational methodologies for processing and harmonizing multiple healthcare and health-related data sources and training machine learning models to generate electronic data useful for actionable financial planning insights. The illustrated embodiments include specialized computer protocols for data harmonization, whereby, for instance, disparate healthcare and health-related electronic datasets undergo systematic integration to enable comprehensive cost predictions. Further, the illustrated embodiments relate to cloud-based deployment computer architectures for both healthcare and LTC analytics, specifically implementing distributed computing methodologies for ML model training and inference. The illustrated embodiments include scalable infrastructure components enabling real-time generation of personalized healthcare and LTC cost predictions preferably through standardized application programming interfaces.

It is to be further appreciated and understood the illustrated embodiments encompass multiple domains including, but not limited to: a) personalized healthcare and LTC analytics and predictive modeling; b) machine learning system implementation; c) data harmonization and integration; d) cloud computing architecture; and e) financial planning computing technology.

The illustrated embodiments described herein addresses, and overcomes, prior art limitations by providing a comprehensive predictive ML computer platform for personalized healthcare and LTC cost estimation. For instance, the computer system and process of the illustrated embodiments generate personalized financial planning insights through integration of multiple electronic data sources. The computer system and process of the illustrated embodiments described herein enables users to (a) generate accurate predictions for healthcare and LTC costs; (b) obtain explainable and actionable insights; and (c) customize projections for various scenarios, using advanced ML modeling and AI techniques.

To achieve these and other advantages and in accordance with the purpose of the illustrated embodiments, in one aspect, described is a computer system and method/process for training an ML model for determining personalized costs associated with healthcare and LTC. Accessed is one or more external datasets including data related to healthcare and LTC, and one or more internal datasets including proprietary data related to LTC, which are then subject to cleansing such that each accessed dataset is suitable for being aggregated in a training dataset for training one or more ML models relating to both personalized healthcare and LTC predictions. A training dataset is then complied by aggregating each of the accessed datasets, wherein the training dataset is operative to train one or more ML models associated with predicting personalized costs relating to healthcare and LTC. ML models for predicting personalized healthcare and LTC costs are trained utilizing the training dataset. The ML models include a plurality of ML models wherein each of the plurality of ML models is configured to implement one or more AI techniques for generating predictions of personalized healthcare costs and LTC costs based on input data associated with a prediction request.

In accordance with another aspect, described is a computer system and method/process for utilizing a trained ML model for determining personalized healthcare and LTC costs. Input data is received relating to a user request for predicted personalized healthcare and LTC costs, which is then preferably preprocessed into a format suitable for utilization by one or more trained ML models. The preprocessed user input data is applied to the trained one or more personalized healthcare and LTC cost ML models each being configured and operative to utilize one or more AI techniques for predicting personalized healthcare and LTC costs predicated upon the preprocessed user input data. Output data is generated from the one or more trained personalized healthcare and LTC cost ML models containing predicted personalized healthcare and LTC costs responsive to the user input data.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an AI device utilized with one or more of the illustrated embodiments;

FIG. 4 illustrates a diagram depicting an AI server utilized with one or more of the illustrated embodiments;

FIG. 5 is a system level diagram depicting a computer system utilized with one or more of the illustrated embodiments associated with personalized healthcare costs;

FIGS. 6 and 7 are flowcharts depicting methods of operation in accordance with one or more of the illustrated embodiments depicted in FIG. 5;

FIG. 8 is a system level diagram depicting a computer system utilized with one or more of the illustrated embodiments associated with costs associated with LTC;

FIGS. 9 and 10 are flowcharts depicting methods of operation in accordance with one or more of the illustrated embodiments depicted in FIG. 8;

FIG. 11 is a system level diagram depicting a computer system utilized with one or more of the illustrated embodiments associated with costs associated with personalized healthcare and LTC costs; and

FIGS. 12 and 13 are flowcharts depicting methods of operation in accordance with one or more of the illustrated embodiments depicted in FIG. 11.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

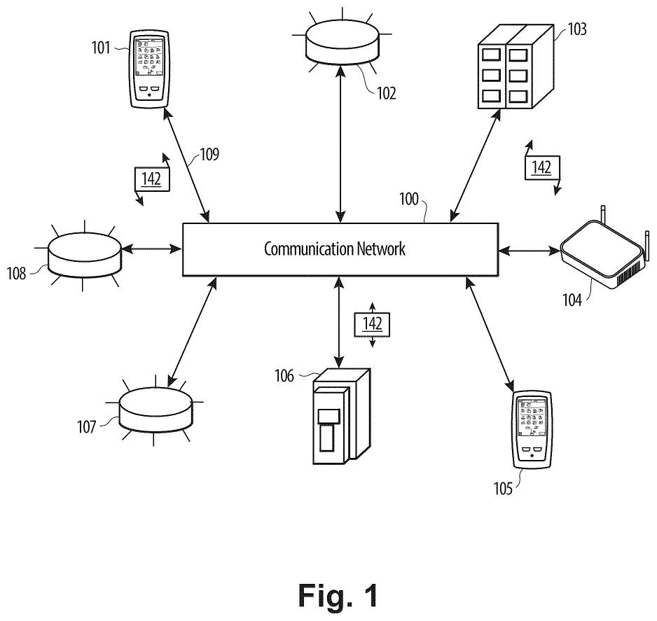

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively including nodes/devices 101-108 (e.g., Personal Digital Assistant Devices (PDAs) 101, sensors 102, computing devices 103, smart phone devices 105, web servers/computer systems 106, computer systems 107, switches 108, internal and external databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP.NET, Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer (e.g., web servers/computer systems 106), or other programmable data processing apparatus to produce a machine, such that the instructions, which execute via the processor of the computer or other programmable data processing apparatus, create means for implementing the functions/acts specified in the flowchart and/or block diagram block or blocks, such as training, and utilizing, an ML model for determining personalized costs associated with healthcare and LTC.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

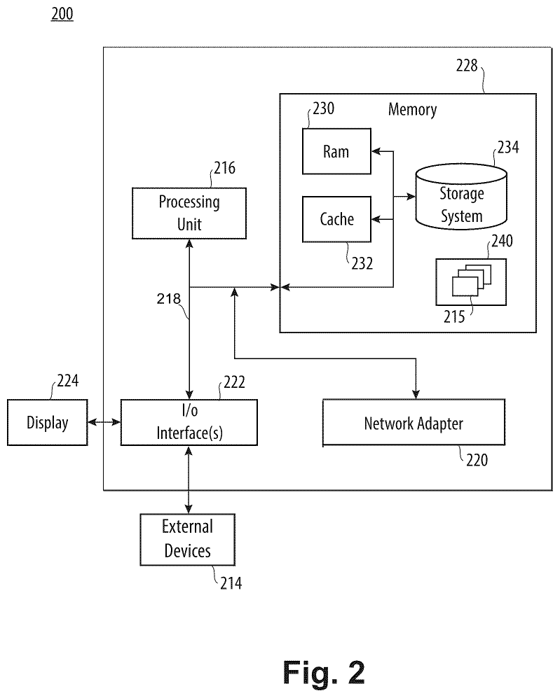

FIG. 2 is a schematic block diagram of an example network computing device 200 (e.g., client computing device 103, web server/computer system 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, including training, and utilizing, an ML model for determining personalized costs associated with healthcare and LTC.

Computing device 200 is operational with numerous other computing system environments or configurations. Examples of well-known computing systems, environments, and/or configurations that may be suitable for use with computing device 200 include, but are not limited to, cloud computing systems (including, but not limited to: Infrastructure as a Service (IaaS); Software as a Service (SaaS); Platform as a Service (PaaS); and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is configured and operative to training, and utilize, an ML model for determining personalized costs associated with healthcare and LTC.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating systems, one or more application programs, other program modules, and program data or some combination thereof, may include an implementation of a networking environment. Program modules 215 generally carry out the functions and/or methodologies of the illustrated embodiments as described herein, including, but not limited to training, and utilizing, an ML model for determining personalized costs associated with healthcare and LTC.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/AI to train, and utilize, an ML model for determining personalized costs associated with healthcare and LTC, amongst other determinations and functionalities, as described herein. Thus, preferably integrated into an ML computer system (e.g., 106) coupled to a plurality of external databases/data sources is an AI system (e.g., an Expert System) that implements ML and AI algorithms to conduct one or more of the above-mentioned related predictions of certain healthcare and LTC cost tasks, preferably on an automated basis. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, AI refers to the field of studying AI or methodology for making AI, and ML refers to the field of defining various issues dealt with in the field of AI and studying methodology for solving the various issues. ML is defined as an algorithm that enhances the performance of a certain task through a steady experience with the certain task.

Also, in accordance with the illustrated embodiments, an artificial neural network (ANN) is a model used in ML and may mean a whole model of problem-solving ability which is composed of artificial neurons (nodes) that form a network by synaptic connections. The ANN can be defined by a connection pattern between neurons in different layers, a learning process for updating model parameters, and an activation function for generating an output value. The ANN may include an input layer, an output layer, and optionally one or more hidden layers. Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the ML algorithm before learning, and includes a learning rate, a repetition number, a mini batch size, and an initialization function. The purpose of the learning of the ANN may be to determine the model parameters that minimize a loss function. The loss function may be used as an index to determine optimal model parameters in the learning process of the ANN. ML may be classified into supervised learning, unsupervised learning, and reinforcement learning according to a learning method. The supervised learning may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation in each state.

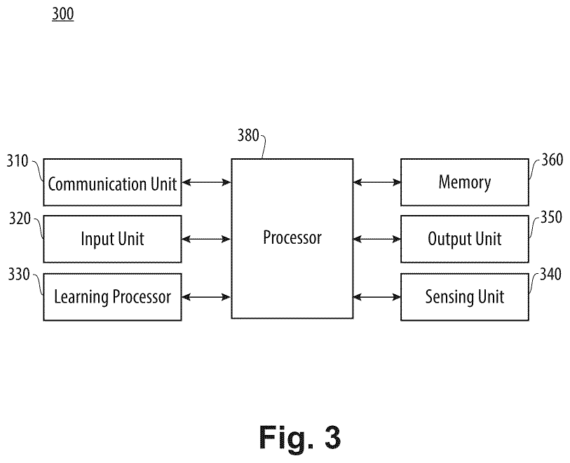

ML, which is preferably implemented as a deep neural network (DNN) including a plurality of hidden layers among ANN, is also referred to as deep learning, and the deep learning is part of ML. FIG. 3 illustrates an AI device 300 according to an illustrated embodiment. In accordance with the illustrated embodiments, the AI device 300 is preferably integrated into a computer system 103 and method/process for training an ML model for determining personalized costs associated with healthcare and LTC.

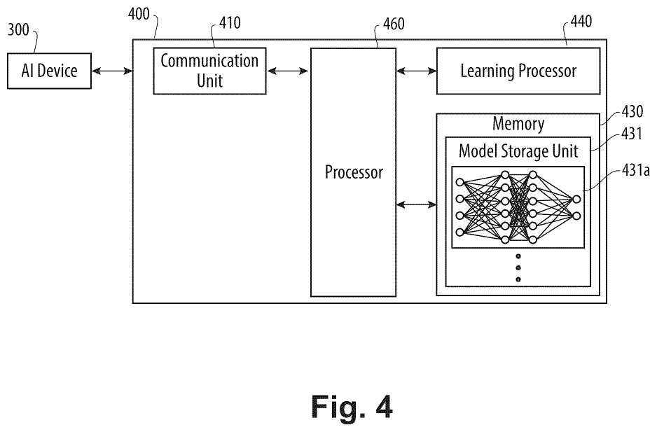

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 360, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 may preferably include GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to health-related data and data relating to personalized healthcare and LTC costs, preferably from both internal databases (e.g., containing proprietary data relating to clients) and external databases (e.g., public record databases relating to health conditions). The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an ANN by using learning data. The learned ANN may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 360, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 360 preferably stores data that supports various functions of the AI device 300. For example, the memory 360 may store input data acquired by the input unit 320, learning data, a learning model, a learning history, and the like.

The processor 380 preferably determines at least one executable operation of the AI device 300 based on information determined or generated by using a data analysis algorithm or an ML algorithm. The processor 380 may control the components of the AI device 300 to execute the determined operation. To this end, the processor 380 may request, search, receive, or utilize data of the learning processor 330 or the memory 360. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may further acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an ANN, at least part of which is learned according to the ML algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI device 300 so as to drive an application program stored in memory 360. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an ANN by using an ML algorithm or uses a learned ANN. The AI server 400 may include a plurality of servers to perform distributed processing or may be defined as a 5G network. At this time, the AI server 400 may be included as a partial configuration of the AI device 300 and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an ANN 431a) through the learning processor 440.

The learning processor 440 may learn the ANN 431a by using the learning data. The learning model may be used in a state of being mounted on the AI server 400 of the ANN or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

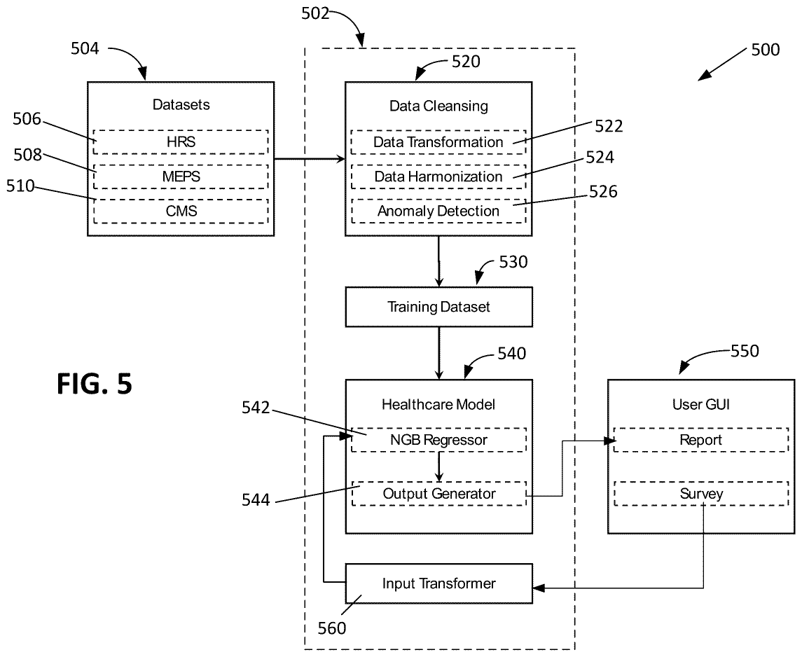

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIG. 5-13. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

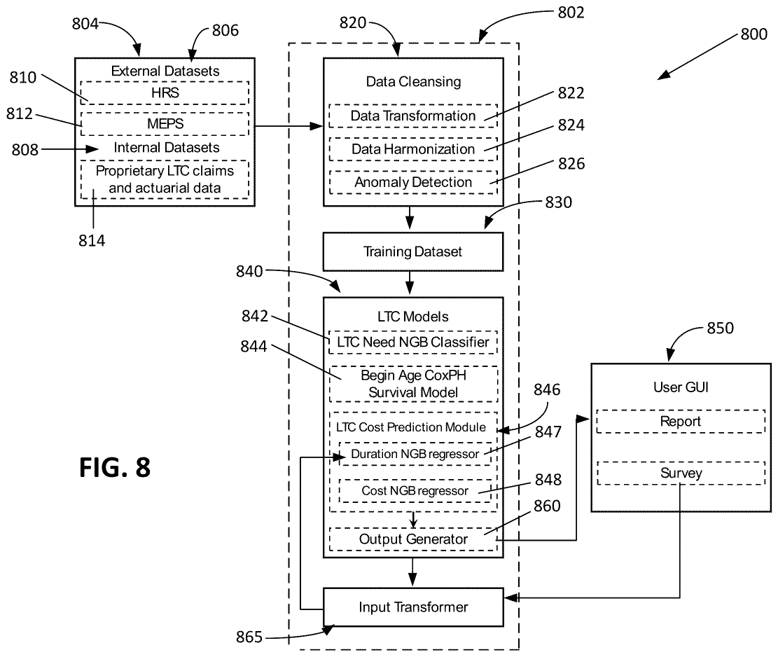

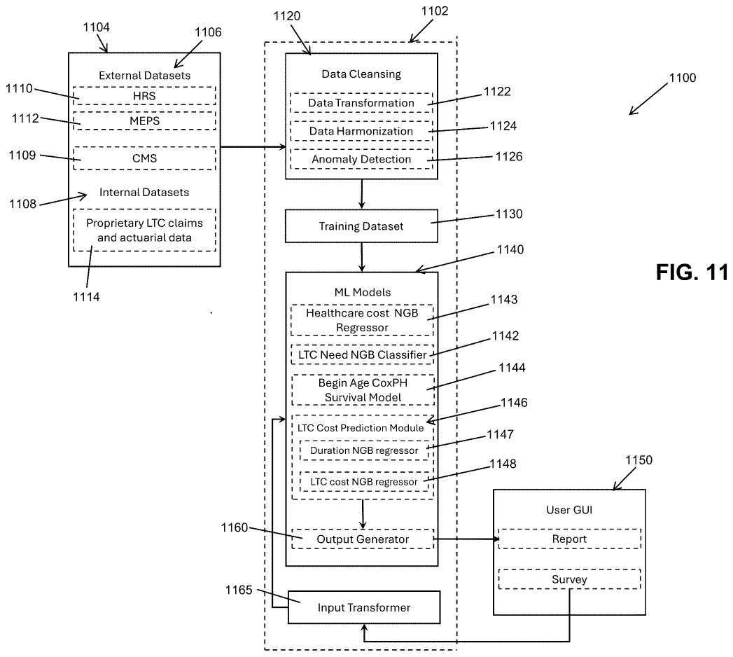

It is to be understood and appreciated, that in accordance with the illustrated embodiments of FIGS. 5-13, multiple data sources (e.g., 504, 804 and 1104) are utilized and processed through specialized methodologies for predicting personalized healthcare and/or LTC costs, as described herein below. For instance, healthcare expenditure data may be derived from publicly available data sources, such as the Health and Retirement Study (HRS) (506, 810, 1110) and the Medical Expenditure Panel Survey (MEPS) (508, 812 and 1112). The below described computer system (e.g., 502 (FIG. 5), 802 (FIG. 8) and 1102 (FIG. 11)) of the illustrated embodiments preferably implements certain selection criteria whereby data is filtered to include records from a certain prescribed time period (e.g., 2010 to 2022), preferably focusing on individuals of all ages. As described herein, the illustrated embodiments described herein preferably utilize a computer system (e.g., 502, 802 and 1102) that includes one or more components of the: a) computer system 200 (FIG. 2, (e.g., computer device 106 of FIG. 1)); b) AI computer device 300 (FIG. 3); and c) AI computer server 400 (FIG. 4).

With regard to illustrated embodiment of FIGS. 5-13, each predictive ML model (e.g., 540, 840 1140) described herein may be optimized through a randomized hyperparameter search protocol, whereby numerous distinct configuration combinations (e.g., 100 combinations) are utilized. This optimization process preferably utilizes specific performance metrics, including mean squared error and adjusted R-squared to refine the predictive capabilities thereof. Each computer system (e.g., 502, 802 and 1102) described herein may be configured and operative to enable generation of probabilistic predictions across multiple healthcare-related domains. For instance, each computer system (e.g., 502, 802 and 1102) is configured and operative to provide: a) a comprehensive approach to handling missing and potentially anomalous data; b) a hybrid methodology combining anomaly detection and regression techniques; c) a process for generating nuanced, probabilistic predictions; and/or d) a systematic approach to model optimization through hyperparameter methodologies.

With regard to yet another aspect of the illustrated embodiments of FIGS. 5-13, each below described computer system's (e.g., 502, 802 and 1102) development and deployment infrastructure may be implemented utilizing Amazon Web Services (AWS) SageMaker (e.g., a fully managed machine learning platform). This development protocol preferably includes utilization of SageMaker notebook instances for data processing, model development, and algorithmic optimization. In operation, the computer system (502, 802, 1102) preferably leverages SageMaker's distributed training capabilities for the implementation of the ML models, as described herein. For instance, the hyperparameter optimization methodology/protocol, which evaluates numerous distinct configurations (e.g., 100 configurations), is preferably executed through Amazon's SageMaker's built-in hyperparameter tuning functionality, enabling systematic exploration of the parameter space while maintaining computational efficiency. Thus, in accordance with the illustrated embodiments, each computer system (e.g., 502, 802 and 1102) may preferably implement a deployment protocol utilizing SageMaker endpoints, whereby the optimized models are deployed as scalable, production-ready inference endpoints, whereby such endpoints enable real-time prediction generation, preferably through a standardized API interface, maintaining consistent performance characteristics while accommodating variable computational demands.

Each computer system of the illustrated embodiments of FIGS. 5-13 (e.g., 502, 802 and 1102) are further configured and operative to implement a data preprocessing protocol (e.g., 520, 820, 1120), whereby numerical variables undergo median imputation, such that missing values are replaced with the median value within the training set. It is noted a particularly innovative aspect of this embodiment is that it involves the processing of categorical variables, whereby missing values are systematically replaced with zero values, and “Not a Number” (NaN) entries are interpreted as “inapplicable”. With regard to another aspect of the illustrated embodiments, specifically relating to anomaly detection, each computer system (e.g., 502, 802 and 1102) is further configured and operative to preferably utilize Cook's distance methodology in conjunction with ordinary least squares regression, whereby the computer system (e.g., 502, 802 and 1102) calculates a statistical measure for each data point and systematically eliminates observations exceeding a data-driven threshold thereof. The Cook's distance (D) of a data point i is defined as

$${D}_{i} = \frac{{\sum }_{j = 1}^{n} {( {\hat{y}}_{j} - {\hat{y}}_{j ( i )} )}^{2}}{p M S E} ,$$

where ŷⱼ is the jth fitted response value, ŷⱼ₍ᵢ₎ is the jth fitted response value, where the fit does not include data point i, MSE is the mean squared error, and p is the number of coefficients in the regression model.

With specific regard now to personalized healthcare cost analysis protocol, as described in each of the below illustrated embodiments of FIGS. 5-7 and FIGS. 11-13, this protocol preferably encompasses multiple expense categories, including, but not limited to, doctor visits, hospital services, outpatient surgery, dental procedures, prescription medications, and additional healthcare services as defined herein. For instance, in operation, the computer system (e.g., 502, 1102) implements a three-stage data processing protocol whereby: (a) health conditions and insurance information variables are systematically identified; (b) observations are retained based on a validity threshold (e.g., 50%) for key variables; and (c) projected costs incorporate an annual inflation adjustment (e.g., 2.5%) of the rate being preferably derived from (but not limited to) the Centers for Medicare & Medicaid Services (CMS) actuarial analyses. The computer system (e.g., 502, 1102) may preferably utilize longitudinal data from the Health and Retirement Study dataset (HRS) (506, 1110), whereby temporal changes in individual health status and care requirements are captured. It is to be appreciated that longitudinal data refers to data that is collected from the same subjects repeatedly over a period of time, which is particularly useful for studying changes and developments over time, as it enables researchers to observe how variables of interest evolve.

In accordance with the illustrated embodiments of FIGS. 5-7 and FIGS. 11-13, the computer system (e.g., 502, 1102) preferably implements, as described further below, a specialized data processing protocol wherein geographic data, demographic data, health conditions, and lifestyle factors undergo standardization and normalization.

With regard to another aspect of the illustrated embodiments of FIGS. 5-7 and FIGS. 11-13, specifically relating to data harmonization, the computer system (e.g., 502, 1102) is configured and operative to implement a data integration protocol whereby data from the HRS and the MEPS datasets (e.g., 506, 508, 1110 and 1112) undergo data harmonization. Preferably, the computer system (e.g., 502, 1102) performs a variable standardization protocol whereby semantically equivalent variables from disparate sources are unified through a systematic mapping process. The computer system (e.g., 502, 1102) preferably implements a standardization protocol whereby the aforesaid data variables are transformed into a unified format, ensuring consistency across the combined dataset. In accordance with this aspect of the illustrated embodiments, the computer system (e.g., 502, 1102) further preferably implements a validation protocol whereby the harmonized variables undergo verification to maintain data integrity. It is noted, this created unified training dataset (e.g., 530, 1130) serves as input for the one or more predictive ML models (e.g., 540, 1140), whereby the enhanced data richness enables significantly increased robustness of predictions than would be possible via prior art systems and methods that were dependent upon single-source data, as will be further described below.

With regard to another aspect of the illustrated embodiments of FIGS. 5-7 and FIGS. 11-13, specifically relating to data storage infrastructure, the computer system (e.g., 502, 1102) is further configured and operative to implement a comprehensive data storage protocol, which may utilize, for instance Amazon Web Services (AWS) Simple Storage Service (S3) (a scalable object storage infrastructure). Preferably, the computer system (e.g., 502, 1102) is operative and configured to maintain distinct storage buckets for raw data ingestion, processed datasets, and model artifacts, whereby HRS and MEPS data (e.g., 506, 508, 1110 and 1112) undergo systematic organization within dedicated storage hierarchies. In operation, the storage protocol preferably implements versioning capabilities, enabling systematic tracking of data transformations and ensuring reproducibility of analytical procedures. The computer system (e.g., 502, 1102) is further configured and operational to implement role-based access control mechanisms, whereby data access is regulated, such as through AWS Identity and Access Management (IAM) policies, ensuring compliance with data security requirements while maintaining operational efficiency.

With regard to another aspect of the illustrated embodiments of FIGS. 5-7 and FIGS. 11-13, specifically relating to training an ML model for determining personalized healthcare costs (e.g., 540, and 1140 with regard to determining personalized healthcare costs), the computer system (e.g., 502, 1102) is preferably configured and operative to perform a comprehensive methodology for transforming raw healthcare data into predictive insights through certain ML computational methodologies, including one or more AI techniques. The computer system (e.g., 502, 1102) may preferably include one or more predictive ML models (e.g., 540, 1140) each preferably addressing distinct aspects of healthcare cost prediction. In operation, the computer system (e.g., 502, 1102) preferably implements a systematic data partitioning protocol, whereby an input dataset (e.g., 504, 1104) undergoes division such that a certain percentage thereof (e.g., 80%) is allocated to a training subset (e.g., 530, 1130) for model development purposes, with the remaining percentage thereof (e.g., 20%) being reserved for validation and performance assessment of a trained ML model (e.g., 540, 1140). It is to be appreciated that such data partitioning ensures robust ML model development while maintaining sufficient data for accurate performance evaluation. Further, it is to be understood the computer system (e.g., 502, 1102) of the illustrated embodiments of FIGS. 5-7 and 11-13 may include multiple specialized models, wherein, for instance a natural gradient boosting (NGB) regressor is implemented for healthcare expense prediction.

As shown in FIG. 5, the system 500 in accordance with this illustrated embodiment preferably includes the computer system 502 coupled to one or more datasets 504, and to one or more client computing devices 550 (as further described below) for performing probabilistic regression for determining personalized healthcare costs expressed as predictive distributions.

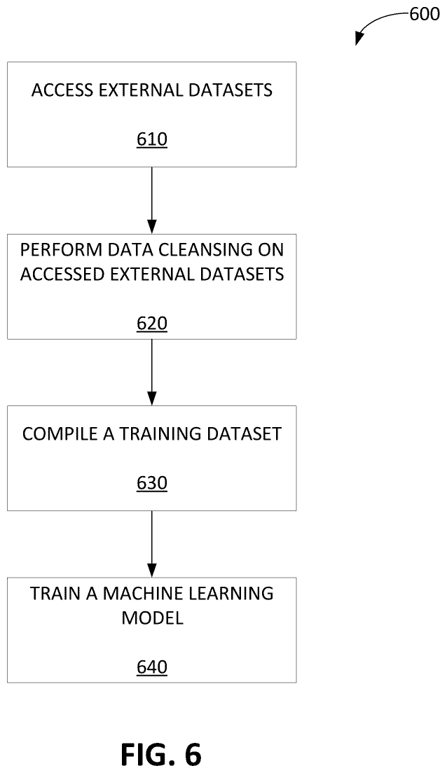

As shown in the illustrated embodiment of FIG. 5, the datasets 504 preferably consist of HRS 506, MEPS 508 and CMS 510 datasets retrieved from publicly available sources, via a communication network 100. The computer system 502 preferably includes a data cleansing module 520 communicatively coupled to the datasets 504 for receiving data therefrom. In accordance with the illustrated embodiment of FIG. 5, the data cleansing module 520 preferably includes: a) a data transformation module 522; b) a data harmonization module 524; and c) an anomaly detection module 526, the functionality of each will be further described below with reference to process 600 of FIG. 6.

The computer system 502 further preferably includes a data training module 530 for generating a dataset (from data retrieved from the datasets 504) configured for training one or more ML model modules in a healthcare ML model 540 generated, and utilized, by the computer system 502, as further described below with reference to process 600 of FIG. 6. In accordance with the illustrated embodiment of FIG. 5, the ML model 540 preferably includes an NGB regressor 542 for performing probabilistic regression on received healthcare related data 504, producing predictive distribution of healthcare costs. Further preferably provided in the computer system 502 is an output generator module 544 configured to receive probabilistic healthcare cost predictions from the ML model 540 and provide output data representative of a request for predicted healthcare costs predicated upon input data. The output generator 544 is operative and configured to interpret and present the ML model's 540 predictions and performance, preferably in a suitable format for use by the client computing device 550. That is, the output generator 544 preferably enhances the usability of the ML model 540 by providing clear, visual, and interpretable results to a client computer device 550 operably coupled to the computer system 502.

As also shown in system 500 of FIG. 5, the aforesaid request for predicted healthcare costs is preferably received by user data inputted to a client computer device 550 (e.g., 103). Preferably, the computer system 502 includes an input transformer module 560 for converting user data provided by the client computer device 550 to a structured format suitable for processing by the healthcare ML model 540 for determining personalized costs associated with healthcare in accordance with the illustrated embodiments.

With the general components of system 500, and computer system 502, being shown above with reference to FIG. 5, its method of operation will now be described with reference to process 600 of FIG. 6 for training an ML model 540 to perform probabilistic regression, thereby determining personalized healthcare costs expressed as predictive distributions. Starting at step 610, data is accessed by computer system 502 (via communication network 100) for one or more datasets 504 including data related to healthcare. As described above, the datasets 504 may consist of a publicly available: 1) a Health and Retirement Study (HRS) dataset 506; 2) a Medical Expenditure Panel Survey (MEPS) dataset 508; and 3) a dataset derived from actuarial studies associated with Centers for Medicare & Medicaid Services (CMS) 510. The HRS 506 and MEPS 508 datasets preferably include historical health-related information and healthcare expenditure information, and the CMS dataset 510 preferably includes inflation data pertaining to healthcare costs.

Next, at step 620, the computer system 502 performs data cleansing (which includes converting unstructured data to structured data) preferably on each of the accessed one or more datasets 504 such that each accessed dataset (e.g., 506-510) is suitable for being aggregated in a training dataset for training one or more ML models 540 relating to healthcare cost predictions. In accordance with the illustrated embodiments, performing data cleansing on each of the accessed one or more datasets 504 includes data transformation techniques consisting of modifying data from each of the accessed datasets (e.g., 506-510) into a common format that is suitable for utilization by an ML model (e.g., 540). For instance, modifying the data from each of the accessed datasets (e.g., 506-510) may include one or more of scaling numerical values, encoding categorical data, imputing missing values with substituted values, and ensuring consistent data types such that an ML model (e.g., 540) can effectively perform predictions based on information provided by the data, preferably via data cleansing module 520. Additionally, performing data cleansing on each of the accessed one or more datasets (e.g., 506-510) may include data harmonization techniques for processing the accessed datasets (e.g., 506-510) into a standardized format, wherein the harmonization techniques may consist of one or more of: a) data cleansing including removing outliers and duplicates and imputing missing values with substituted values; b) data mapping including identifying corresponding fields across different datasets and mapping them to a common schema; c) data standardization including converting data to a consistent format; and d) data normalization including scaling data to a common range to minimize bias, preferably via data harmonization module 524. And further in accordance with the illustrated embodiments, accessed HRS 506 and MEPS 508 datasets are processed by the computer system 502 to determine harmonization, including standardization and normalization, of geographic data, demographic data, health conditions data, and lifestyle factor data, preferably via data harmonization module 524.

The computer system 502 is additionally configured and operative to perform anomaly detection techniques for processing the accessed datasets 504 into a standardized format and wherein the anomaly detection techniques preferably consist of processing the accessed datasets for identifying and removing unusual data points (outliers) from an accessed dataset 504 before using it to train an ML model (e.g., 540), preferably via anomaly detection module 526. It is to be understood the anomaly detection techniques may preferably consist of utilizing Cook's distance methodology with ordinary least squares regression, whereby the computing system 502: a) calculates a statistical measure for each data point in the datasets 504; and b) eliminates observations that exceed data-driven threshold derived from the statistical measure before using it to train an ML model (e.g., 540).

Next, at step 630, the computer system 502 is operative and configured to compile a training dataset 530 by aggregating each of the accessed datasets (e.g., 506-510), wherein the training dataset 530 is operative to train one or more ML models 540 associated with predicting costs relating to healthcare in accordance with the illustrated embodiments.

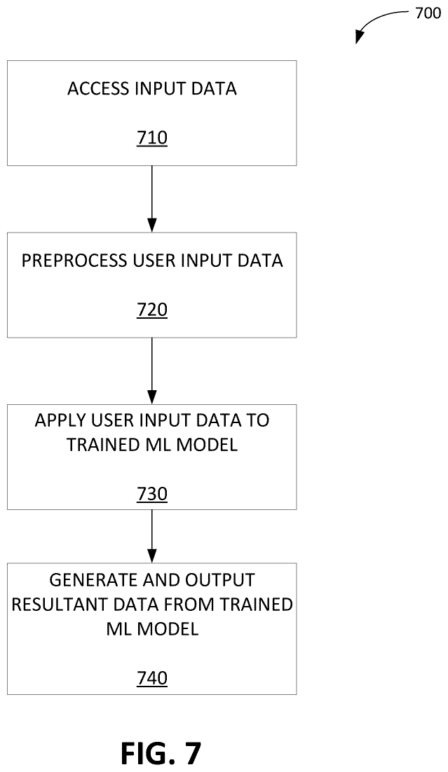

Once the training dataset 530 is compiled (step 630), at step 640 the computer system 502 trains a healthcare cost ML model 540 including one or more ML model modules (e.g., 542) each being configured and operative to utilize one or more AI techniques for predicting personalized healthcare costs predicted upon certain input data (e.g., via computing device 550) related to a request for such predictions. In accordance with certain illustrated embodiments, the trained healthcare cost ML model 540 may consist of at least an NGB regressor 542 configured for determining predicted healthcare costs based upon the information provided by the accessed datasets (e.g., 506-510) and may be further configured to generate probabilistic predictions across multiple health-related domains. Further, the trained ML model 540 is preferably optimized through a randomized hyperparameter search protocol, including utilizing performance metrics, including mean squared error and adjusted R-squared for refining predictive capabilities. The computer system 502 preferably further evaluates the accuracy of the trained ML model 540 for predicting costs associated with healthcare by utilizing mean squared error and adjusted R-squared for optimizing performance. In certain embodiments, computer system 502 is further caused to apply NLP techniques to transform at least a portion of text data in the training dataset 530 to a data format compatible for training the ML model 540. Further, in certain embodiments, the computer system 502 is operative and configured such that the trained ML model 540 is updated in real-time with data from at least one dataset 504. With the process 600 and system 500 for training an ML model for determining personalized cost associated with healthcare being described above with reference to FIGS. 5 and 6, description is now provided for a process 700, and with reference to FIG. 7, for utilizing a trained ML model, by a computer system (e.g., 502), for determining personalized costs associated with healthcare based upon a user input request.

Starting at step 710, user data is preferably provided in a partner/client computing device 550 (e.g., 103 FIG. 1) relating to a user request for predicted personalized costs associated with healthcare, which data is then provided to the computer system 502 communicatively coupled to the user client device 550, preferably via an input transformer 560, and a communication network 100. As mentioned above, the input transformer 560 provided in the computer system 502 preferably preprocesses the user input data into a format that can be utilized by the trained ML model 540, step 720.

Next, at step 730, the preprocessed user input data (step 720) is applied to the trained healthcare cost ML model 540 including one or more ML model modules (e.g., 542) each being configured and operative to utilize one or more AI techniques for predicting personalized healthcare costs, expressed as predictive distribution, predicated upon the preprocessed user input data (step 710). At step 740, the trained ML model 540 processes the applied user input data (step 730), using one or more of the aforementioned AI techniques, to generate, and output, data from the trained healthcare cost ML model 540 containing predicted personalized healthcare costs responsive to the user input data (step 710). For instance, and as shown in FIG. 5 (and as described above), the computer system 502 preferably includes an output generator 544 operative to provide output data representative of a request for predicted healthcare costs predicated upon the user input data (step 710) by the ML model 740 which is preferably converted to an interpretable format for use by a client computer device 550.

With the illustrated embodiments of FIGS. 5-7 being shown and discussed above with regard to predicting personalized healthcare costs, description of certain illustrated embodiments will now be provided with below reference to FIG. 8-13 (and with continuing reference to FIGS. 1-4) to a system (e.g., 800, 1100) and processes (900, 1000, 1200 and 1300) for training, and utilizing, ML models for determining personalized costs associated with LTC.

With specific regard to healthcare cost analysis protocol described in the below illustrated embodiments of FIGS. 8-13, it is to be understood and appreciated, multiple data sources (e.g., 804, 1104) are utilized and processed through specialized methodologies for predicting LTC, as described herein. For instance, health-related data may be derived from publicly available data sources, such as the Health and Retirement Study (HRS) (810, 1110) and the Medical Expenditure Panel Survey (MEPS) (812, 1112), and LTC expenditure data may be derived from the internal proprietary datasets (808, 1108). The below computer system 106 of the illustrated embodiments of FIGS. 8-13 (e.g., 802, 1102) preferably implements certain selection criteria whereby data is filtered to include records from a certain prescribed time period (e.g., 2010 to 2022), preferably focusing on individuals of all ages.

The LTC cost analysis protocol, as further described below in accordance with the illustrated embodiments of FIGS. 8-13, preferably encompasses multiple expense categories, including, but not limited to, in-home care, assisted living facility, and nursing home as defined herein. For instance, in operation, the computer system (e.g., 802, 1102) implements a three-stage data processing protocol whereby: (a) health conditions variables are systematically identified; (b) observations are retained based on a validity threshold (e.g., 50%) for key variables; and (c) projected costs incorporate an annual inflation adjustment (e.g., 3%) of the rate being preferably derived from (but not limited to) the internal datasets (e.g., 808, 1108).

With regard to LTC onset prediction, and in accordance with another aspect of the illustrated embodiments of FIGS. 8-13, the computer system (e.g., 802, 1102) may preferably utilize longitudinal data from the HRS (810, 1110) and MEPS (812, 1112) datasets, whereby temporal changes in individual health status and care requirements are captured. It is to be appreciated that longitudinal data refers to data that is collected from the same subjects repeatedly over a period of time, which is particularly useful for studying changes and developments over time, as it enables researchers to observe how variables of interest evolve.

In accordance with the illustrated embodiments of FIGS. 8-13, the computer system (e.g., 802, 1102) preferably implements, as described further below, a specialized data processing protocol wherein: (a) time-to-event data is constructed through identification of first recorded instances of: LTC utilization; LTC service implementation; or presence of two or more activities of daily living (ADL) limitations; (b) geographic data, demographic data, health conditions, and lifestyle factors undergo standardization and normalization; and (c) right-censoring is implemented for subjects without recorded LTC service utilization within the observation period.

With regard to LTC need assessment, and in accordance with certain illustrated embodiments of FIGS. 8-13, the computer system (e.g., 802, 1102) is further configured and operational to implement a comprehensive assessment protocol utilizing data from both HRS and MEPS datasets (e.g., 810, 812, 1110 and 1112) specifically relating to LTC, whereby the HRS data components (810, 1110) may include functional limitation variables including, but not limited to, difficulties in: a) bathing; b) dressing; c) eating; d) walking; and e) incontinence management. And the MEPS data components (812, 1112) preferably encompasses data from a prescribed time period (e.g., 2017 to 2020) and encompass subjects aged in a prescribed age group (e.g., 0 to 85 years), which preferably includes functional limitation variables including, but not limited to, difficulties in, for instance: a) bending; b) bathing; c) dressing; d) executing errands; and e) finger dexterity. Preferably, each computer system (802, 1102) is configured and operative such that each functional limitation undergoes binary variable conversion, whereby presence or absence of difficulty is indicated. Each computer system (802, 1102) preferably generates a composite variable representative of the quantity of ADLs an individual cannot perform, wherein subjects unable to perform two or more such activities are classified as requiring LTC.

With regard to another aspect of the illustrated embodiments of FIGS. 8-13, and again specifically relating to LTC claims data, proprietary data (e.g., insurance claims data) is derived from an entity's LTC insurance claims internal data repository (e.g., 808, 1108). For instance, such LTC claims data may include: a) claimant geographic and demographic information; b) claim initiation justifications; c) care duration metrics; and d) monetary claim quantities. Preferably, each computer system (802, 1102) described herein processes and integrates these multiple data sources to enable comprehensive LTC predictions, as will be further described below.

With regard to another aspect of the illustrated embodiments of FIGS. 8-13, specifically relating to data harmonization, each computer system (802, 1102) is further configured and operational to preferably implement a data integration protocol whereby data from the HRS and the MEPS datasets (e.g., 810, 812, 1110 and 1112) undergo harmonization. Preferably, each computer system (802, 1102) performs a variable standardization protocol whereby semantically equivalent variables from disparate sources are unified through a systematic mapping process. In operation, each computer system (802, 1102) identifies and processes analogous variables, such as functional limitations including, but not limited to, bathing and dressing difficulties, which are present in both HRS and MEPS datasets (e.g., 810, 812, 1110 and 1112).

Each computer system of the illustrated embodiments of FIGS. 8-13 (802, 1102) is further preferably configured and operational to implement a standardization protocol whereby the aforesaid data variables are transformed into a unified format, ensuring consistency across the combined dataset. In accordance with this aspect of the illustrated embodiments of FIGS. 8-13, the computer system (802, 1102) further preferably implements a validation protocol whereby the harmonized variables undergo verification to maintain data integrity. It is noted, this unified training dataset created (e.g., 830, 1130) serves as input for the multiple predictive models (e.g., 840, 1140), whereby the enhanced data richness enables significantly increased robustness of predictions than would be possible via prior art systems and methods that were dependent upon single-source data, as will be further described below.

With regard to yet another aspect of the illustrated embodiments, and specifically relating to data storage infrastructure, each computer system (802, 1102) is further configured and operative to implement a comprehensive data storage protocol, which may utilize, for instance Amazon Web Services (AWS) Simple Storage Service (S3) (a scalable object storage infrastructure). Preferably, each computer system (802, 1102) is operative and configured to maintain distinct storage buckets for raw data ingestion, processed datasets, and model artifacts, whereby HRS and MEPS data (e.g., 810, 812, 1110 and 1112), and any proprietary datasets (e.g., 814, 1114) undergo systematic organization within dedicated storage hierarchies. In operation, the storage protocol preferably implements versioning capabilities, enabling systematic tracking of data transformations and ensuring reproducibility of analytical procedures. Each computer system (802, 1102) is further configured and operational to implement role-based access control mechanisms, whereby data access is regulated, such as through AWS Identity and Access Management (IAM) policies, ensuring compliance with data security requirements while maintaining operational efficiency.

With regard to another aspect of the illustrated embodiments of FIGS. 8-13, specifically relating to training ML models (e.g., 840, 1140), the computer system (802, 1102) is configured and operative to perform a comprehensive methodology for transforming raw health and LTC related data into predictive insights through certain computational methodologies, including one or more AI techniques. Each computer system (802, 1102) may preferably include multiple predictive models (e.g., 840, 1140) each preferably addressing distinct aspects of LTC prediction. In operation, each computer system (802, 1102) preferably implements a systematic data partitioning protocol, whereby an input dataset (e.g., 804, 1104) undergoes division such that a certain percentage thereof (e.g., 80%) is allocated to a training subset (e.g., 830, 1130) for model development purposes, with the remaining percentage thereof (e.g., 20%) being reserved for validation and performance assessment of trained ML models (e.g., 840, 1140). It is to be appreciated that such data partitioning ensures robust model development while maintaining sufficient data for accurate performance evaluation.

Further, it is to be understood each computer system (802, 1102) of the illustrated embodiments of FIGS. 8-13, and with regard to LTC assessment, may include multiple specialized models, wherein, for instance: a) a first NGB regressor is implemented for LTC duration prediction; b) an NGB classifier is utilized for LTC need assessment; and c) a second NGB regressor is employed for LTC expense prediction.

With regard to yet another aspect of the illustrated embodiments of FIGS. 8-13 and relating to LTC onset prediction, each computer system (802, 1102) is preferably configured and operative to utilize a Cox Proportional Hazards (CoxPH) model for LTC onset prediction. Thus, each computer system (802, 1102) provides sophisticated handling of censored observations, preferably defined as instances, where the initiation of LTC services remains unobserved within a certain time period (e.g., a study period). Each computer system (802, 1102) may preferably synthesize multiple indicators to determine the onset of LTC needs. For instance, such indicators may include (and are not limited to): a) residency status in nursing homes or institutional care facilities; b) utilization of home care services; and c) presence of functional limitations, such as, two or more ADL impairments.

With specific regard to the illustrated embodiment of FIG. 8, the system 800 preferably includes the computer system 802 coupled to one or more datasets 804, preferably consisting of one or more digital external datasets 806, and one or more digital internal datasets 808 for performing probabilistic determination of LTC.

As shown in the illustrated embodiment of FIG. 8, the external datasets 806 preferably consists of HRS 810 and MEPS 812 datasets retrieved from publicly available sources, preferably via a communication network 100. And the internal datasets 808 preferably consists of data related to LTC insurance claims data and LTC actuarial data 814, preferably both retrieved from an internal proprietary source (e.g., an insurance company). The system 800 further encompasses one or more client computing devices 850 (as further described below).

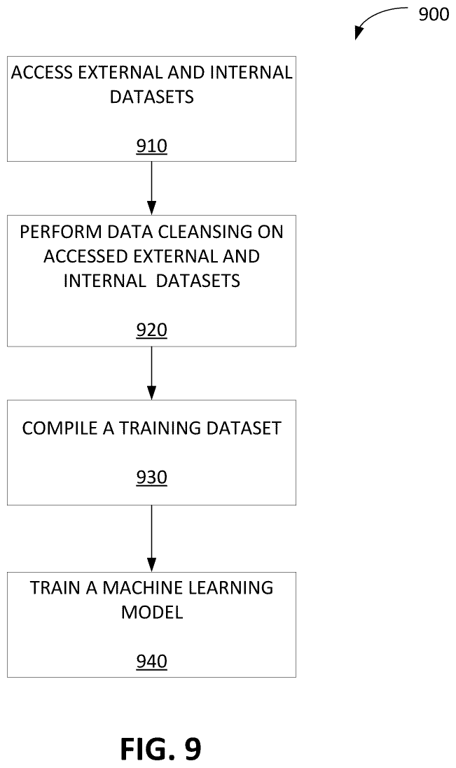

The computer system 802 preferably further includes a data cleansing module 820 communicatively coupled to each of the external 806 and internal 808 dataset for receiving data therefrom. In accordance with the illustrated embodiment of FIG. 8, the data cleansing module 820 preferably includes: a) a data transformation module 822; b) a data harmonization module 824; and c) an anomaly detection module 826, the functionality of each will be further described below with reference to process 900 of FIG. 9. The computer system 802 further preferably includes a data training module 830 for generating a dataset (from data retrieved from each of the external 806 and internal 808 datasets) configured for training one or more ML models in an LTC ML module 840 generated, and utilized, by the computer system 802, as further described below with reference to process 900 of FIG. 9.

In accordance with the illustrated embodiment of FIG. 8, the ML module 840 is preferably configured and operative to generate probabilistic predictions across multiple health-related domains, and preferably consists of one or more of: 1) an LTC need NGB classifier 842 operative to determine the probability of one or more individuals requiring LTC during their remaining lifespan; 2) a begin age CoxPH survival model 844 operative to perform a probabilistic prediction of an age at which one or more individuals will require the commencement of LTC; and 3) an LTC prediction module 846. The LTC prediction module 846 may preferably consist of one or more of a) a duration NGB regressor 847 operative to perform probabilistic regression and predict the duration of LTC utilization for one or more individuals, and b) a cost NGB regressor 848 operative to perform probabilistic regression and predict the LTC costs during the remaining lifespan of one or more individuals. Both regressors can produce predictive distributions.

Further preferably provided in the computer system 802 is an output generator module 860 configured to provide output data representative of a request for predicted LTC costs predicated preferably upon user input data. The output generator 860 is operative and configured to interpret and present the ML model's 840 predictions and performance, preferably in a suitable format for use by a communicatively coupled client/partner computing device 850. That is, the output generator 860 preferably enhances the usability of the ML module 840 by providing clear, visual, and interpretable results to a client/partner computer device 850. As also shown in system 800 of FIG. 8, the aforesaid request for predicted LTC costs is preferably received by user data inputted via a client/partner computer device 850 (e.g., computer device 103). Preferably, the computer system 802 further includes an input transformer module 865 for converting user data provided by the client/partner computer device 850 to a structured format suitable for processing by the LTC ML models 840 for determining personalized LTC costs in accordance with the illustrated embodiments.

With the general components of computer system 800 being shown above with reference to FIG. 8, its method of operation will now be described with reference to process 900 of FIG. 9 for training ML models 840 to perform probabilistic regression, thereby determining personalized LTC costs, expressed as predictive distributions. Starting at step 910, data is accessed by computer system 802 (preferably via communication network 100) from the one or more datasets 804, preferably consisting of one or more digital external datasets 806, and one or more digital internal datasets 808. In accordance with the illustrated embodiment of FIG. 8, the external datasets 806 may consist of publicly available a: 1) HRS dataset 810; and 2) MEPS dataset 812, and wherein the internal datasets 808 may consist of a proprietary dataset 814 associated with LTC insurance claims data and LTC actuarial data. For instance, with regard to the external datasets 806, the HRS dataset 810 may include functional limitation variables associated with one or more of: bathing; dressing; eating; walking; and incontinence management, and the MEPS dataset 812 may include functional limitation variables associated with one or more of: bending; bathing; dressing; executing errands; and finger dexterity. And with regard to the internal datasets 808 (e.g., 814), preferably included is insurance claims data associated with one or more of: claimant geographic and demographic information; claim initiation justifications; care duration metrics; and monetary claim quantities.

Next, at step 920, the computer system 902 preferably performs data cleansing (which includes converting unstructured data to structured data) preferably on each of the accessed one or more external 806 and internal 808 datasets such that each accessed dataset (e.g., 810, 812, and 814) is suitable for being aggregated in a training dataset 830 for training one or more ML models 840 relating to LTC cost predictions. In accordance with the illustrated embodiments, performing data cleansing on each of the accessed one or more external 806 and internal 808 datasets (e.g., 810, 812, and 814) includes data transformation techniques consisting of modifying data from each of the accessed datasets (e.g., 810, 812 and 814) into a common format that is suitable for utilization by ML models (e.g., 840). For instance, modifying the data from each of the accessed datasets (e.g., 810, 812 and 814) may include one or more of scaling numerical values, encoding categorical data, imputing missing values with substituted values, and ensuring consistent data types such that ML models (e.g., 840) can effectively perform predictions based on information provided by the aforesaid accessed data, preferably via data transformation module 822. Additionally, performing data cleansing on each of the accessed datasets (e.g., 810, 812 and 814) may include data harmonization techniques for processing the accessed datasets (e.g., 810, 812 and 814) into a standardized format, wherein the harmonization techniques may consist of one or more of: a) data cleansing including removing outliers and duplicates and imputing missing values with substituted values; b) data mapping including identifying corresponding fields across different datasets and mapping them to a common schema; data standardization including converting data to a consistent format; and c) data normalization including scaling data to a common range to minimize bias, preferably via data harmonization module 824. And further in accordance with the illustrated embodiments of FIGS. 8-10, accessed HRS 810 and MEPS 812 datasets are preferably processed by the computer system 802 to determine harmonization, including standardization and normalization, of geographic data, demographic data, health conditions data, and lifestyle factor data, preferably via data harmonization module 824.

Additionally, the computer system 802, preferably in the data cleansing step (step 920), may be further configured and operative, responsive to data accessed for the external 806 and internal 808 datasets, to determine: a) time-to-event data constructed through identification of first recorded instances of one or more of nursing home care utilization, homecare service implementation, or presence of two or more ADL limitations; b) harmonization, including standardization and normalization, of geographic data, demographic data, health conditions data, and lifestyle factor data; and c) right-censoring for data associated with subjects not having recorded LTC service utilization within a prescribed observation period.

The computer system 802 is further additionally configured and operative to perform anomaly detection techniques for processing the accessed external 806 and internal 808 datasets into a standardized format and wherein the anomaly detection techniques preferably consist of processing the accessed external 806 and internal 808 datasets for identifying and removing unusual data points (e.g., outliers) from a training dataset 830 before using it to train ML models (e.g., 840), preferably via anomaly detection module 826. It is to be understood the anomaly detection techniques may preferably consist of utilizing Cook's distance methodology with ordinary least squares regression, whereby the computing system 802: a) calculates a statistical measure for each data point in the dataset 804; and b) eliminates observations that exceed data-driven threshold derived from the statistical measure before using it to train ML models (e.g., 840).

Next, at step 930, the computer system 802 is operative and configured to compile a training dataset 830 by aggregating each of the accessed external 806 and internal 808 datasets (e.g., 810, 812 and 814), wherein the training dataset 830 is operative to train one or more ML models 840 associated with predicting costs relating to LTC in accordance with the illustrated embodiments. Preferably, compiling a training dataset 830 includes performing data labelling techniques on data aggregated from the accessed external 806 and internal 808 datasets (e.g., 810, 812 and 814) such that the one or more ML models 840 perform supervised learning techniques predicated upon the training dataset 830.

Once the training dataset 830 is compiled (step 930), at step 940 the computer system 802 trains LTC cost ML models 840 preferably including one or more ML models (e.g., 842, 844, and 846) each being configured and operative to utilize one or more AI techniques for predicting LTC costs predicted upon certain input data related to a request for such predictions. In accordance with the exemplary illustrated embodiment of FIG. 8, the ML models 840, as mentioned above, preferably consists of one or more of: 1) an LTC need NGB classifier 842 operative to determine the probability of one or more individuals requiring LTC during their remaining lifespan; 2) a begin age CoxPH survival model 844 operative to perform a probabilistic prediction of an age at which one or more individuals will require the commencement of LTC; and 3) an LTC prediction ML module 846. The LTC prediction module 846 may preferably consist of one or more of: a) a duration NGB regressor 847 operative to predict the duration of LTC utilization for one or more individuals, and b) a cost NGB regressor 848 operative to predict the LTC costs during the remaining lifespan of one or more individuals.

Preferably, each of the one or more ML model modules (e.g., 842, 844 and 846) in the trained ML models 840 is optimized through a randomized hyperparameter search protocol, including utilizing performance metrics, including mean squared error and adjusted R-squared for regression, balanced accuracy for classification, and a concordance index for survival modeling for optimizing predictive capabilities. Additionally, and in accordance with certain illustrated embodiments, the trained LTC cost ML models 840 are preferably configured to synthesize multiple indicators to determine onset of LTC needs, wherein the indicators may consist of one or more of: residency status in nursing homes or institutional care facilities; utilization of home care services; and presence of functional limitations.

Further, and in accordance with certain illustrated embodiments, the computer system 802 preferably evaluates the accuracy of the trained ML models 840 for predicting costs associated with LTC, wherein the accuracy evaluation may consists of one or more of: 1) utilizing balanced accuracy for optimizing performance of a binary classification model; 2) utilizing mean squared error and adjusted R-squared for optimizing performance of a regression model; and 3) utilizing concordance index for optimizing performance of a survival model. And in certain embodiments, computer system 802 is further caused to perform NLP techniques to transform at least a portion of text data in the training dataset 830 to a data format compatible for training ML models 840. Further, in certain embodiments, the computer system 802 is further operative and configured such that the trained ML models 840 are updated in real-time with data from one or more of the datasets 804 (e.g., 806 and 808).

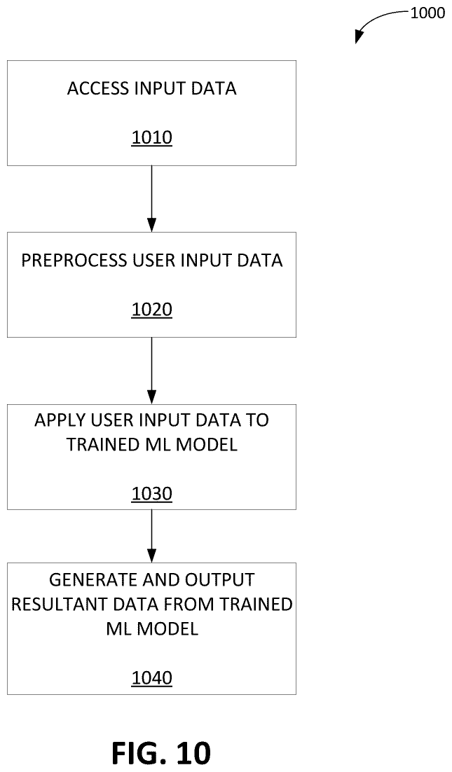

With the system 800 and process 900 for training an ML model for determining LTC cost being described above with reference to FIGS. 8 and 9, description is now provided for a process 1000, with reference to FIG. 10, for utilizing trained ML models (e.g., 840), by a computer system (e.g., 802), for determining LTC costs based upon a user input request.

Starting at step 1010, user data is preferably provided in a client/partner computing device 850 (e.g., 103 FIG. 1) relating to a user request for predicted LTC costs, which data is then provided to the computer system 802 communicatively coupled to the user client/partner device 850, preferably via an input transformer 865. As mentioned above, the input transformer 865 provided in the computer system 802 preferably preprocesses the user input data into a format that can be utilized by the trained ML learning models 840, step 1020.

Next, at step 1030, the preprocessed user input data (step 1020) is applied to the trained LTC cost ML models 840 including one or more ML model modules (e.g., 842, 844, 847 and 848) each being configured and operative to utilize one or more AI techniques for predicting LTC costs, expressed as predictive distribution, predicated upon the preprocessed user input data (step 1010). At step 1040, the trained ML models 840 processes the applied user input data (step 1030), using one or more of the aforementioned AI techniques, to generate, and output, data from the trained LTC cost ML models 840 containing predicted personalized LTC costs responsive to the user input data (step 1010). For instance, and as shown in FIG. 8 (and as described above), the computer system 802 preferably includes an output generator 860 operative to provide output data representative of a request for predicted LTC costs predicated upon the user input data (step 1010) by the trained ML models 840 which are preferably converted to an interpretable format for use by a client/partner computer device 850.

With the illustrated embodiments of FIGS. 5-10 being shown and discussed above with regard to predicting personalized healthcare costs (FIGS. 5-7) and LTC costs (FIGS. 8-10), description of certain illustrated embodiments will now be provided with below reference to FIG. 11-13 (and with continuing reference to FIGS. 1-4) to a system 1100, and processes 1200 and 1300 for training, and utilizing, ML models for determining both personalized healthcare costs and personalized costs associated with LTC.

As shown in FIG. 11, system 1100 in accordance with the illustrated embodiments preferably includes the computer system 1102 coupled to one or more datasets 1104, preferably consisting of one or more digital external datasets 1106, and one or more digital internal datasets 1108. The external datasets 1106 preferably consists of CMS 1109, HRS 1110 and MEPS 1112 datasets retrieved from publicly available sources, preferably via a communication network 100. And the internal datasets 1108 preferably consists of data related to LTC insurance claims data and LTC actuarial data 1114, preferably both retrieved from an internal proprietary source (e.g., an insurance company). The system 1100 further encompasses one or more client computing devices 1150 (as further described below).

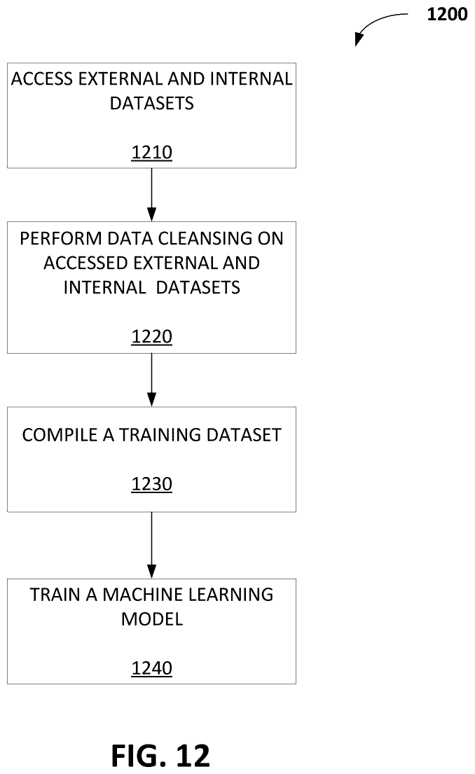

The computer system 1102 further includes a data cleansing module 1120 communicatively coupled to each of the external 1106 and internal 1108 datasets for receiving data therefrom. In accordance with the illustrated embodiment of FIG. 11, the data cleansing module 1120 may include: a) a data transformation module 1122; b) a data harmonization module 1124; and c) an anomaly detection module 1126, the functionality of each will be further described below with reference to process 1200 of FIG. 12.

The computer system 1102 may further include a data training module 1130 for generating a dataset (from data retrieved from each of the external 1106 and internal 1108 datasets) configured for training one or more ML models in an ML module 1140 generated, and utilized, by the computer system 1102, as further described below with reference to process 1200 of FIG. 12.

In accordance with the illustrated embodiment of FIG. 11, the ML module 1140 is preferably configured and operative to generate probabilistic predictions across multiple health-related domains, and may consist of one or more of: 1) an LTC need NGB classifier 1142 operative to determine the probability of one or more individuals requiring LTC during their remaining lifespan; 2) an NGB regressor 1143 for performing probabilistic regression on received healthcare related data 1104 and producing predictive distribution of healthcare costs; 3) a begin age CoxPH survival model 1144 operative to perform a probabilistic prediction of an age at which one or more individuals will require the commencement of LTC; and 4) an LTC cost prediction module 1146. The LTC cost prediction module 1146 may consist of one or more of: a) a duration NGB regressor 1147 operative to perform probabilistic regression and predict the duration of LTC utilization for one or more individuals; and b) a cost NGB regressor 1148 operative to perform probabilistic regression and predict the LTC costs during the remaining lifespan of one or more individuals. It is to be understood but aforesaid regressors can produce predictive distributions.

Further preferably provided in the computer system 1102 is an output generator module 1160 configured to provide output data representative of a request for predicted personalized healthcare costs and/or LTC costs predicated upon user input data (e.g., via client device 1150). The output generator 1160 is operative and configured to interpret and present the ML model's 1140 predictions and performance, preferably in a suitable format for use by a communicatively coupled client/partner computing device 1150. That is, the output generator 1160 preferably enhances the usability of the ML module 1140 by providing clear, visual, and interpretable results to a client/partner computer device 1150. As also shown in system 1100 of FIG. 11, the aforesaid request for predicted personalized healthcare and/or LTC costs is preferably received by user data inputted via a client/partner computer device 1150 (e.g., 103). Preferably, the computer system 1102 further includes an input transformer module 1165 for converting user data provided by the client/partner computer device 1150 to a structured format suitable for processing by the LTC ML models 1140 for determining personalized LTC costs in accordance with the illustrated embodiments.

With the general components of computer system 1100 being shown above with reference to FIG. 11, its method of operation will now be described with reference to process 1200 of FIG. 12 for training ML models 1140 to perform probabilistic regression, thereby determining personalized Healthcare and/or LTC costs, expressed as predictive distributions. Starting at step 1210, data is accessed by computer system 1102 (preferably via communication network 100) from the one or more datasets 1104, preferably consisting of one or more digital external datasets 1106, and one or more digital internal datasets 1108. In accordance with the illustrated embodiment of FIG. 11, the external datasets 1106 may consist of a publicly available: 1) CMS 1109 dataset; 2) HRS dataset 1110; and 3) MEPS dataset 1112, and wherein the internal datasets 1108 may consist of a proprietary dataset 1114 associated with LTC insurance claims data and LTC actuarial data. For instance, with regard to the external datasets 1106, the HRS dataset 1110 may include functional limitation variables associated with one or more of: bathing; dressing; eating; walking; and incontinence management, and the MEPS dataset 1112 may include functional limitation variables associated with one or more of: bending; bathing; dressing; executing errands; and finger dexterity. And with regard to the internal datasets 1108 (e.g., 1114), preferably included is insurance claims data associated with one or more of: claimant geographic and demographic information; claim initiation justifications; care duration metrics; and monetary claim quantities.

Next, at step 1220, the computer system 1102 preferably performs data cleansing (which includes converting unstructured data to structured data) preferably on each of the accessed one or more external 1106 and internal 1108 datasets such that each accessed dataset (e.g., 1109, 1110, 1112, and 1114) is suitable for being aggregated in a training dataset 1130 for training one or more ML models 1140 relating to personalized healthcare and/or LTC cost predictions. In accordance with the illustrated embodiments, performing data cleansing on each of the accessed one or more external 1106 and internal 1108 datasets (e.g., 1109, 1110, 1112, and 1114) includes data transformation techniques consisting of modifying data from each of the accessed datasets (e.g., 1109, 1110, 1112 and 1114) into a common format that is suitable for utilization by ML models (e.g., 1140). For instance, modifying the data from each of the accessed datasets (e.g., 1109, 1110, 1112 and 1114) may include one or more of scaling numerical values, encoding categorical data, imputing missing values with substituted values, and ensuring consistent data types such that ML models (e.g., 1140) can effectively perform predictions based on information provided by the aforesaid accessed data, preferably via data transformation module 1122. Additionally, performing data cleansing on each of the accessed datasets (e.g., 1109, 1110, 1112 and 1114) may include data harmonization techniques for processing the accessed datasets (e.g., 1109, 1110, 1112 and 1114) into a standardized format, wherein the harmonization techniques may consist of one or more of: a) data cleansing including removing outliers and duplicates and imputing missing values with substituted values; b) data mapping including identifying corresponding fields across different datasets and mapping them to a common schema; data standardization including converting data to a consistent format; and c) data normalization including scaling data to a common range to minimize bias, preferably via data harmonization module 1124. And further in accordance with the illustrated embodiments, accessed HRS 1109, 1110 and MEPS 1112 datasets are preferably processed by the computer system 1102 to determine data harmonization, including standardization and normalization, of geographic data, demographic data, health conditions data, and lifestyle factor data, preferably via data harmonization module 1124.

Additionally, the computer system 1102, preferably in the data cleansing step (step 1220), may be further configured and operative, responsive to data accessed for the external 1106 and internal 1108 datasets, to determine: a) time-to-event data constructed through identification of first recorded instances of one or more of nursing home care utilization, homecare service implementation, or presence of two or more ADL limitations; b) harmonization, including standardization and normalization, of geographic data, demographic data, health conditions data, and lifestyle factor data; and c) right-censoring for data associated with subjects not having recorded LTC service utilization within a prescribed observation period.

The computer system 1102 is further additionally configured and operative to perform anomaly detection techniques for processing the accessed external 1106 and internal 1108 datasets into a standardized format and wherein the anomaly detection techniques preferably consist of processing the accessed external 1106 and internal 1108 datasets for identifying and removing unusual data points (e.g., outliers) from a training dataset 1130 before using it to train ML models (e.g., 1140), preferably via anomaly detection module 1126. It is to be understood the anomaly detection techniques may preferably consist of utilizing Cook's distance methodology with ordinary least squares regression, whereby the computing system 1102: a) calculates a statistical measure for each data point in the dataset 1104; and b) eliminates observations that exceed data-driven threshold derived from the statistical measure before using it to train ML models (e.g., 1140).

Next, at step 1230, the computer system 1102 is operative and configured to compile a training dataset 1130 by aggregating each of the accessed external 1106 and internal 1108 datasets (e.g., 1109, 1110, 1112 and 1114), wherein the training dataset 1130 is operative to train one or more ML models 1140 associated with predicting costs relating to LTC in accordance with the illustrated embodiments. Preferably, compiling a training dataset 1130 includes performing data labelling techniques on data aggregated from the accessed external 1106 and internal 1108 datasets such that the one or more ML models 1140 perform supervised learning techniques predicated upon the training dataset 1130.

Once the training dataset 1130 is compiled (step 1230), at step 1240 the computer system 1102 trains the healthcare and LTC cost ML models 1140 preferably including one or more ML models (e.g., 1142, 1143, 1144, and 1146) each being configured and operative to utilize one or more AI techniques for predicting personalized healthcare and/or LTC costs, expressed as predictive distributions, predicted upon certain input data related to a request for such predictions. In accordance with the exemplary illustrated embodiment of FIG. 11, the ML models 1140, as mentioned above, preferably consists of one or more of: 1) an LTC need NGB classifier 1142 operative to determine the probability of one or more individuals requiring LTC during their remaining lifespan; 2) an NGB regressor 1143 for performing probabilistic regression on received healthcare related data 1104, producing predictive distribution of healthcare costs; 3) a begin age CoxPH survival model 1144 operative to perform a probabilistic prediction of an age at which one or more individuals will require the commencement of LTC; and 4) an LTC prediction ML module 1146. The LTC prediction module 1146 may preferably consist of one or more of a) a duration NGB regressor 1147 operative to predict the duration of LTC utilization for one or more individuals, and b) a cost NGB regressor 1148 operative to predict the LTC costs during the remaining lifespan of one or more individuals.

Preferably, each of the one or more ML model modules (e.g., 1142, 1143, 1144 and 1146) in the trained ML models 1140 is optimized through a randomized hyperparameter search protocol, including utilizing performance metrics, including mean squared error and adjusted R-squared for regression, balanced accuracy for classification, and a concordance index for survival modeling for optimizing predictive capabilities. Additionally, and in accordance with certain illustrated embodiments, the trained personalized healthcare and LTC cost ML models 1140 are preferably configured to synthesize multiple indicators to determine onset of LTC needs, wherein the indicators may consist of one or more of: residency status in nursing homes or institutional care facilities; utilization of home care services; and presence of functional limitations.

Further, and in accordance with certain illustrated embodiments, the computer system 1102 preferably evaluates the accuracy of the trained ML models 1140 for predicting costs associated with personalized healthcare and/or LTC, wherein the accuracy evaluation may consists of one or more of: 1) utilizing balanced accuracy for optimizing performance of a binary classification model; 2) utilizing mean squared error and adjusted R-squared for optimizing performance of a regression model; and 3) utilizing concordance index for optimizing performance of a survival model. And in certain embodiments, computer system 1102 is further caused to perform NLP techniques to transform at least a portion of text data in the training dataset 1130 to a data format compatible for training ML models 1140. Further, in certain embodiments, the computer system 1102 is further operative and configured such that the trained ML models 1140 are updated in real-time with data from one or more of the datasets 1104.

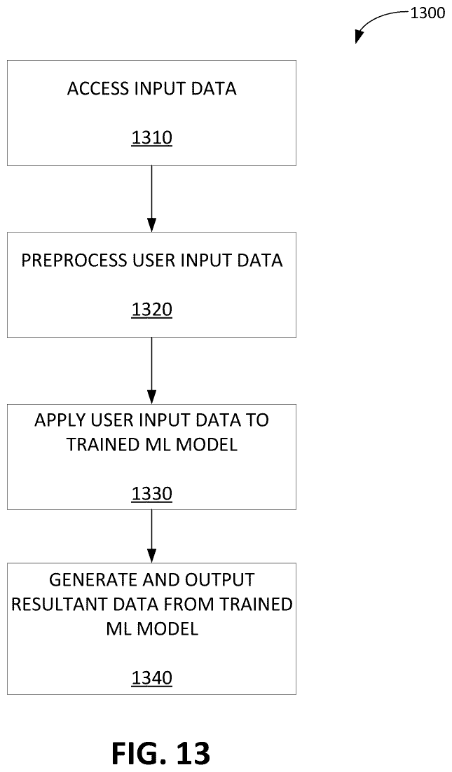

With the system 1100 and process 1200 for training an ML model for determining LTC cost being described above with reference to FIGS. 11 and 12, description is now provided for a process 1300, with reference to FIG. 13, for utilizing trained ML models (e.g., 1140), by a computer system (e.g., 1102), for determining personalized healthcare and/or LTC costs based upon a user input request.

Starting at step 1310, user data is preferably provided in a client/partner computing device 1150 (e.g., 103 FIG. 1) relating to a user request for predicted personalized healthcare and/or LTC costs, which data is then provided to the computer system 1102 communicatively coupled to the user client/partner device 1150, preferably via an input transformer 1165. As mentioned above, the input transformer 1165 provided in the computer system 1102 preferably preprocesses the user input data into a format that can be utilized by the trained ML learning models 1140, step 1320.

Next, at step 1330, the preprocessed user input data (step 1320) is applied to the trained healthcare and LTC cost ML models 1140 including one or more ML model modules (e.g., 1142, 1143, 1144, 1147 and 1148) each being configured and operative to utilize one or more AI techniques for predicting personalized healthcare and/or LTC costs, expressed as predictive distribution, predicated upon the preprocessed user input data (step 1310). At step 1340, the trained ML models 1140 processes the applied user input data (step 1330), using one or more of the aforementioned AI techniques, to generate, and output, data from the trained personalized healthcare and LTC cost ML models 1140 containing predicted personalized healthcare and/or LTC costs responsive to the user input data (step 1310). For instance, and as shown in FIG. 11 (and as described above), the computer system 1102 preferably includes an output generator 1160 operative to provide output data representative of a request for predicted personalized healthcare and/or LTC costs predicated upon the user input data (step 1310) by the trained ML models 1140 which are preferably converted to an interpretable format for use by a client/partner computer device 1150.

It is to be appreciated and understood the illustrated embodiments for determining personalized healthcare and/or LTC costs by training, and utilizing, an ML model provides a technical improvement to prior computer systems and processes for determining personalized healthcare and/or LTC costs, which typically were dependent upon single-source data (e.g., an actuarial produced dataset). Thus, it is to be further appreciated that the illustrated embodiments provide a transformative computer-implemented process for personalized healthcare and LTC cost predictions. For instance, by leveraging advanced data processing and ML techniques as described above, the above-described computer system (e.g., 1102) and processes (e.g., 1200 and 1300) provides unprecedented insights into potential personalized healthcare and LTC trajectories which were not formerly capable of being performed by any prior art techniques.

Thus, the above-described illustrated embodiments provides a technical improvement to computer prediction system and processes by, for instance, enabling multiple practical applications across various domains within the healthcare and financial services sectors. For example, in one implementation, insurance providers utilize the system's predictive capabilities for enhanced underwriting processes, whereby personalized risk assessments are generated through integration of multiple health indicators and demographic factors. The computer system (e.g., 1102) enables actuaries to generate more precise premium calculations through comprehensive analysis of potential health trajectories and associated personalized healthcare and LTC costs. In another implementation, financial advisors leverage the system's (e.g., 1102) predictive insights for retirement financial planning purposes, whereby the system generates personalized projections of potential personalized healthcare and LTC expenses. Such projections enable more accurate estimation of retirement savings requirements, accounting for various health scenarios and care needs that may arise during retirement years.

It is to be appreciated and understood, in one exemplary implementation, healthcare and LTC providers may implement the system (e.g., 1100) for resource allocation planning, whereby predictions of care needs and duration enable more efficient staffing and facility management. It is to be further appreciated the system's (e.g., 1100) ability to predict LTC onset timing and duration, through the above-described ML and AI techniques, provides valuable insights for capacity planning and service delivery optimization.

In accordance with yet another implementation of the above-described illustrated embodiments, government agencies and policy makers may utilize the system's (e.g., 1100) analytical capabilities for population health management, and healthcare and LTC policy development. In this regard, the system (e.g., 1100) enables sophisticated modeling of personalized healthcare and LTC cost trends and LTC needs across different demographic segments, facilitating evidence-based policy decisions and resource allocation strategies.

In accordance with still another implementation of the above-described illustrated embodiments, individual consumers and their financial advisors may implement the system (e.g., 1100) for personalized financial planning, whereby the predictive insights enable more informed decisions regarding one or more of: a) retirement savings strategies; b) LTC insurance procurement; c) healthcare and LTC coverage selection; and d) estate planning considerations.

Thus, the computer system (e.g., 1100) in accordance with the illustrated embodiments described herein provide practical value across multiple stakeholder categories within the healthcare and LTC and financial services ecosystem, enabling enhanced decision-making capabilities through sophisticated predictive analytics.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computing system for training a machine learning model for determining personalized costs associated with long-term care and healthcare, expressed as predictive distribution, comprising:
one or more processors; and
one or more computer-readable media having stored thereon computer-executable instructions that are structured such that, when executed by the one or more processors, cause the computing system at least to:
access one or more external datasets including data related to long-term care and healthcare;
access one or more internal datasets including proprietary data related to long-term care;
perform data cleansing on each of the accessed one or more external and internal datasets such that each accessed dataset is suitable for being aggregated in a training dataset for training one or more machine learning models relating to personalized predictions of long-term care and healthcare;
compile a training dataset by aggregating each of the accessed datasets, wherein the training dataset is operative to train one or more machine learning models associated with predicting personalized costs relating to long-term care and healthcare; and
train a machine learning model including one or more machine learning model modules each being configured and operative to utilize one or more artificial intelligence techniques for predicting personalized costs associated with long-term care and healthcare, predicted upon certain input data related to a request for such predictions.

2. The computing system for training a machine learning model as recited in claim 1, wherein the trained machine learning model further includes an output generator module configured to provide output data representative of the request for at least one of personalized predicted long-term care costs and healthcare costs, predicated upon certain input data.

3. The computing system for training a machine learning model as recited in claim 1, wherein the external datasets consist of publicly available: 1) a Health and Retirement Study dataset; 2) a Medical Expenditure Panel Survey dataset, and 3) a dataset derived from actuarial studies associated with Centers for Medicare & Medicaid Services (CMS), and wherein the internal datasets consist of: 1) a proprietary dataset associated with long-term care insurance claims data; and 2) a proprietary dataset associated with long-term care actuarial data.

4. The computing system for training a machine learning model as recited in claim 3, wherein the Health and Retirement Study and Medical Expenditure Panel Survey datasets are processed by the one or more processors to determine: a) time-to-event data constructed through identification of first recorded instances of one or more of nursing home utilization, home care service implementation, or presence of two or more limitations in activities of daily living; b) harmonization, including standardization and normalization, of geographic data, demographic data, health conditions data, and lifestyle factor data; and c) right-censoring for data associated with subjects not having recorded long-term care service utilization within an observation period.

5. The computing system for training a machine learning model as recited in 3, wherein the Health and Retirement Study dataset includes functional limitation variables associated with one or more of: bathing; dressing; eating; walking; and incontinence management, and the Medical Expenditure Panel Survey dataset includes functional limitation variables associated with one or more of: bending; bathing; dressing; executing errands; and finger dexterity.

6. The computing system for training a machine learning model as recited in claim 3, wherein the internal datasets include insurance claims data associated with one or more of: claimant geographic and demographic information; claim initiation justifications; long-term care duration metrics; and monetary claim quantities.

7. The computing system for training a machine learning model as recited in claim 3, wherein the HRS and MEPS datasets include historical health-related information and healthcare expenditure information, and the CMS dataset includes inflation data pertaining to healthcare costs.

8. The computing system for training a machine learning model as recited in claim 3, wherein performing data cleansing on each of the accessed one or more external and internal datasets includes data transformation techniques consisting of modifying data from each of the accessed external and internal datasets into a common format that is suitable for utilization by a machine learning model.

9. The computing system for training a machine learning model as recited in claim 8, wherein modifying the data from each of the accessed external and internal datasets includes one or more of: scaling numerical values; encoding categorical data; imputing missing values with substituted values; and providing consistent data types such that the trained machine learning model effectively performs predictions based on information provided by the accessed one or more external and internal datasets.

10. The computing system for training a machine learning model as recited in claim 1, wherein performing data cleansing on each of the accessed one or more external and internal datasets includes data harmonization techniques for processing the accessed external and internal datasets into a standardized format.

11. The computing system for training a machine learning model as recited in claim 10, wherein the harmonization techniques consist of one or more of: data cleansing, including removing outliers and duplicates and imputing missing values with substituted values; data mapping, including identifying corresponding fields across different datasets and mapping them to a common schema; data standardization, including converting data to a consistent format; and data normalization, including scaling data to a common range to minimize bias.

12. The computing system for training a machine learning model as recited in claim 11, wherein performing data cleansing on each of the accessed one or more external and internal datasets further includes anomaly detection techniques for processing the accessed external and internal datasets into a standardized format, wherein the anomaly detection techniques consist of processing the accessed external and internal datasets for identifying and removing outlier data points from a dataset before using it to train a machine learning model.

13. The computing system for training a machine learning model as recited in claim 12, wherein the anomaly detection techniques further consist of utilizing Cook's distance algorithm with ordinary least squares regression, whereby the computing system: calculates a statistical measure for each data point in the accessed datasets; and eliminates observations that exceed data-driven threshold derived from the statistical measure before using it to train a machine learning model.

14. The computing system for training a machine learning model as recited in claim 1, wherein compiling a training dataset includes performing data labelling techniques on data aggregated from the accessed external and internal datasets such that a machine learning model performs supervised learning predicated upon the training dataset.

15. The computing system for training a machine learning model as recited in claim 1, wherein the trained model consists of one or more of: 1) a first natural gradient boosting regressor configured for determining long-term care duration expressed as predictive distribution; 2) an natural gradient boosting classifier configured for determining long-term care need assessment; 3) a second natural gradient boosting regressor configured for determining long-term care expenses expressed as predictive distribution; and 4) a Cox Proportional Hazards survival model configured for determining long-term care begin age for one or more individuals.

16. The computing system for training a machine learning model as recited in claim 1, wherein the trained model consists of at least a natural gradient boosting regressor configured for determining predicted healthcare costs based upon the information provided by the accessed external datasets.

17. The computing system for training a machine learning model as recited in claim 16, wherein the trained model is further configured to generate probabilistic predictions across multiple health-related domains, expressed as predictive distribution.

18. The computing system for training a machine learning model as recited in claim 1, wherein the trained model is configured to synthesize multiple indicators to determine onset of long-term care needs, wherein the indicators consist of one or more of: residency status in nursing homes or institutional care facilities; utilization of home care services; and presence of functional limitations.

19. The computing system for training a machine learning model as recited in claim 1, wherein each of the one or more ML model modules is optimized through a randomized hyperparameter search protocol, including utilizing performance metrics, including mean squared error and adjusted R-squared for regression, balanced accuracy for classification, and concordance index for survival modeling for optimizing predictive capabilities.

20. The computer system for training a machine learning model as recited in claim 1, wherein the computer system is further caused to convert unstructured data to structured data suitable for training the machine learning model.

21. The computer system for training a machine learning model as recited in claim 1, wherein the computer system is further caused to perform natural language processing techniques to transform at least a portion of text data in the accessed dataset to a data format compatible for training the machine learning models.

22. The computer system for training a machine learning model as recited in claim 1, wherein the computer system is further caused to evaluate the accuracy of the trained machine learning model for predicting costs associated with long-term care, wherein the evaluation consists of: 1) utilizing balanced accuracy for optimizing performance of a binary classification model; 2) utilizing mean squared error and adjusted R-squared for optimizing performance of a regression model; and 3) utilizing concordance index for optimizing performance of a survival model.

23. A computer-implemented process for training a machine learning model for determining personalized costs associated with long-term care and healthcare, expressed as predictive distribution, comprising the steps:
accessing one or more external datasets including data related to long-term care and healthcare;
accessing one or more internal datasets including proprietary data related to long-term care;
performing data cleansing on each of the accessed one or more external and internal datasets such that each accessed dataset is suitable for being aggregated in a training dataset for training one or more machine learning models relating to personalized predictions of long-term care and healthcare;
compiling a training dataset by aggregating each of the accessed datasets, wherein the training dataset is operative to train one or more machine learning models associated with predicting personalized costs relating to long-term care and healthcare; and
training a machine learning model including one or more machine learning model modules each being configured and operative to utilize one or more artificial intelligence techniques for predicting personalized costs associated with long-term care and healthcare, predicted upon certain input data related to a request for such predictions.

24. A computer-implemented method that utilizes a trained machine learning model for determining personalized costs associated with long-term care and/or personalized costs associated with healthcare, expressed as predictive distribution, comprising the steps:
accessing input data relating to a user request for predicted personalized costs associated with long-term care and/or personalized costs associated with healthcare;
preprocessing the user input data into a format that can be utilized by the trained machine learning model;
applying the preprocessed user input data to the trained long-term care model including one or more machine learning model modules each being configured and operative to utilize one or more artificial intelligence techniques for predicting personalized long-term care costs, and personalized costs associated with healthcare, predicated upon the preprocessed user input data; and
generating and output data from the trained long-term care cost model containing predicted personalized long-term care costs, and/or personalized costs associated with healthcare, responsive to the user input data.
